(19) United States
(12) Patent Application Publication
(10) Pub. No.: US 2020/0032581 A1
(43) Pub. Date: Jan. 30, 2020

(54) Variable Window Treatment

(71) Applicants: Joseph G. Englert, JR., Colchester, VT (US); Joseph G. Englert, SR., Walworth, NY (US)

(72) Inventors: Joseph G. Englert, JR., Colchester, VT (US); Joseph G. Englert, SR., Walworth, NY (US)

(21) Appl. No.: 16/510,947

(22) Filed: Jul. 14, 2019

Related U.S. Application Data
(60) Provisional application No. 62/711,011, filed on Jul. 27, 2018.

(51) Int. Cl. E06B 9/58; E06B 9/44; E06B 9/70

(52) U.S. Cl. CPC E06B 9/58; E06B 2009/587; E06B 9/70; E06B 9/44

(57) ABSTRACT

A device for variably covering an area includes a first shade and a first driver. The first shade includes a first roller, a first draw bar, and a first curtain. The first roller is configured for mounting in a first fixed position. The first curtain has one end connected to the first roller and another end connected to the first draw bar. The first curtain is windable on the first roller to uncover the area and unwindable from the roller to cover the area. The first draw bar includes two ends, and the first driver is connected to the two ends for evenly pulling the first draw bar away from the first roller and unwinding the first curtain.

### FIELD

This patent application generally relates to techniques for variably covering an area. More particularly, this application is related to techniques for covering a desired portion of the area. Even more particularly, this patent application is related to techniques for covering a desired portion of the area while leaving other portions uncovered.

### BACKGROUND

Shades have been used to cover an area, such as a window. But shades have not been able to cover desired portions while leaving other portions uncovered. Improvement has been needed, and such an improvement is provided by the current patent application.

### SUMMARY

One aspect of the present patent application is a device for variably covering an area. The device includes a first shade and a first driver. The first shade includes a first roller, a first draw bar, and a first curtain. The first roller is configured for mounting in a first fixed position. The first curtain has one end connected to the first roller and another end connected to the first draw bar. The first curtain is windable on the first roller to uncover the area and unwindable from the roller to cover the area. The first draw bar includes two ends, and the first driver is connected to the two ends for evenly pulling the first draw bar away from the first roller and unwinding the first curtain.

Another aspect of the present patent application is a device for variably covering an area. The device includes a first shade and a second shade. The first shade includes a first roller, a first draw bar, and a first curtain. The first roller is configured for mounting in a first fixed position. The first curtain has one end connected to the first roller and another end connected to the first draw bar. The second shade includes a second roller, a second draw bar, and a second curtain. The second roller is configured for mounting in a second fixed position substantially orthogonal to the first roller. The second curtain has one end connected to the second roller and another end connected to the second draw bar. When the first and the second curtains are extended to cover the area, the first curtain extends in a plane in front of the second curtain.

Another aspect of the present patent application is a method of using a device for variably covering an area. The method includes: providing a first shade and a second shade. The first shade includes a first roller, a first draw bar, and a first curtain. The first curtain has one end connected to the first roller and another end connected to the first draw bar. The second shade includes a second roller, a second draw bar, and a second curtain. The second curtain has one end connected to the second roller and another end connected to the second draw bar. The method further includes mounting the first roller in a first fixed position and mounting the second roller in a second fixed position substantially orthogonal to the first roller. When the first and the second curtains are extended, the first curtain extends in a plane in front of the second curtain.

### BRIEF DESCRIPTION OF DRAWINGS

The foregoing and other aspects and advantages of the invention will be apparent from the following detailed description as illustrated in the accompanying drawings, in which:

FIG. 1a is a front view of a portion of one embodiment of a device for variably covering an area that includes a shade a driver, and a transmission, in which the shade includes a roller, a draw bar, and a curtain;

FIG. 1b is an exploded view of the embodiment of the device of FIG. 1a showing additional shades and drivers as well as transmissions;

FIG. 1c is a front view of the embodiment of FIG. 1a showing the additional shades, drivers and transmissions;

FIG. 1d is a three quarter view of the embodiment of FIG. 1a showing an enlarged view of shades, drivers and transmissions;

FIG. 1e is a three quarter view of draw bar ends through which lead screw transmissions extend or connect;

FIG. 1f is a three quarter view of draw bars and lead screw transmission;

FIG. 2a is a front view of another embodiment of a device for variably covering an area that has two sets of simultaneously turned lead screws and lead screw nuts, one set on each side of each shade;

FIG. 2b is a front view of the embodiment of a device of FIG. 2a showing a second pair of lead screws, lead screw nuts, and motors used to operate a second shade;

FIG. 3a is a front view of another embodiment of a device for variably covering an area that has lead screws and cords 54a of its transmissions driven by a hand crank;

FIG. 3b is a three quarter view of the embodiment of FIG. 3a showing an enlarged view of pulleys, lead screws, and bevel gears;

FIG. 3c is another three quarter view of the embodiment of FIG. 3a showing an enlarged view of hand cranks operating on bevel gears;

FIG. 4a is a front view of a single shade of another embodiment of a device for variably covering an area that has driver and transmission combined in a hand pull cord operated with pulleys;

FIG. 4b is a front view of the embodiment of FIG. 4a showing operation of multiple shades with hand pull cords;

FIG. 4c is a three quarter view of the embodiment of FIG. 4b showing an enlarged view of pulleys operated by hand pull cords and draw bars that are stablized by non-rotating support bars;

FIG. 4d is a three quarter view of the embodiment of FIG. 4c showing an enlarged view of hand pull cords;

FIG. 4e is a front view of the embodiment of FIG. 4b mounted in a frame;

FIG. 4f is a front view of the embodiment of FIG. 4a with two shades mounted orthogonal to each other, each with driver and transmission combined in a hand pull cord operated with pulleys;

FIG. 5a is a three quarter view of a controller;

FIG. 5b is a block diagram of electronic control for a four-shade system, including motors, motor drivers, processor, and controller as connected through the internet;

FIG. 5c is a front view of a hand-held mobile device that has a touch screen that uses a program allowing a user to select which window shade system to adjust;

FIG. 6a is a flow chart showing steps of a process running on CPU 102 used to operate the motors of the embodiment of FIG. 1a through the controller of FIG. 5a;

FIG. 6b is a flow chart showing steps of a process running on CPU 102 used to operate the motors of the embodiment of FIG. 1a when a computing device, such as hand-held mobile device, is used to issue instruction for operation of motors;

### DETAILED DESCRIPTION

The present inventors created apparatus and method for variably covering portions of an opening, such as a window.

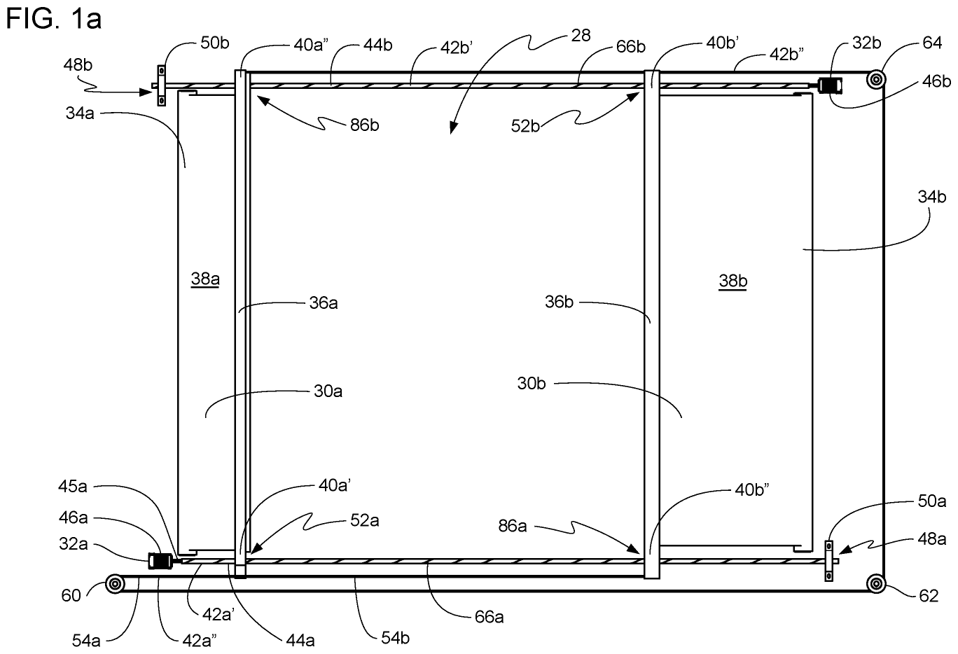

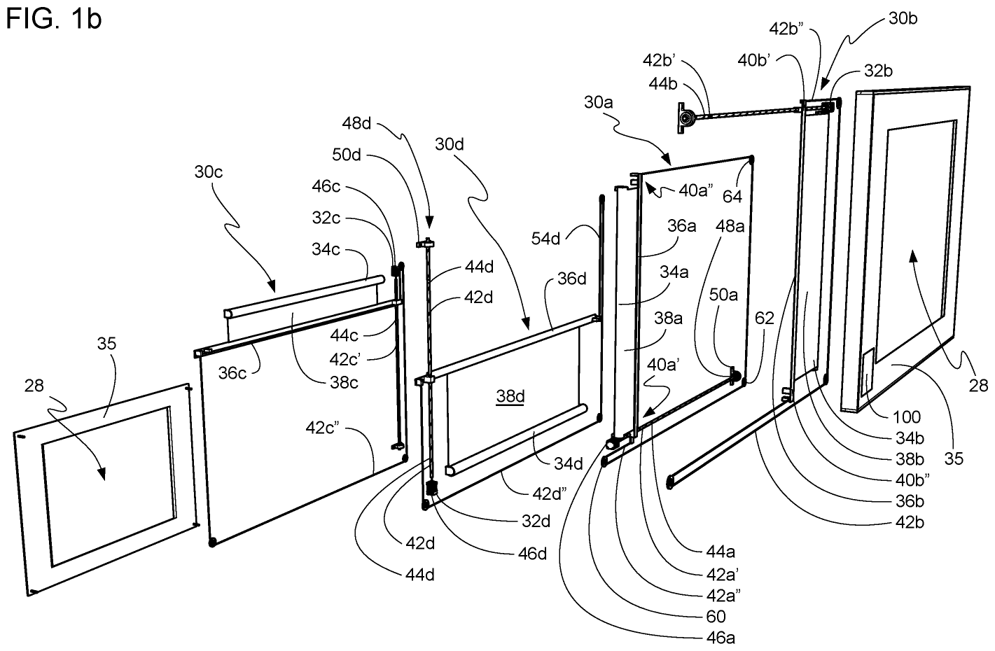

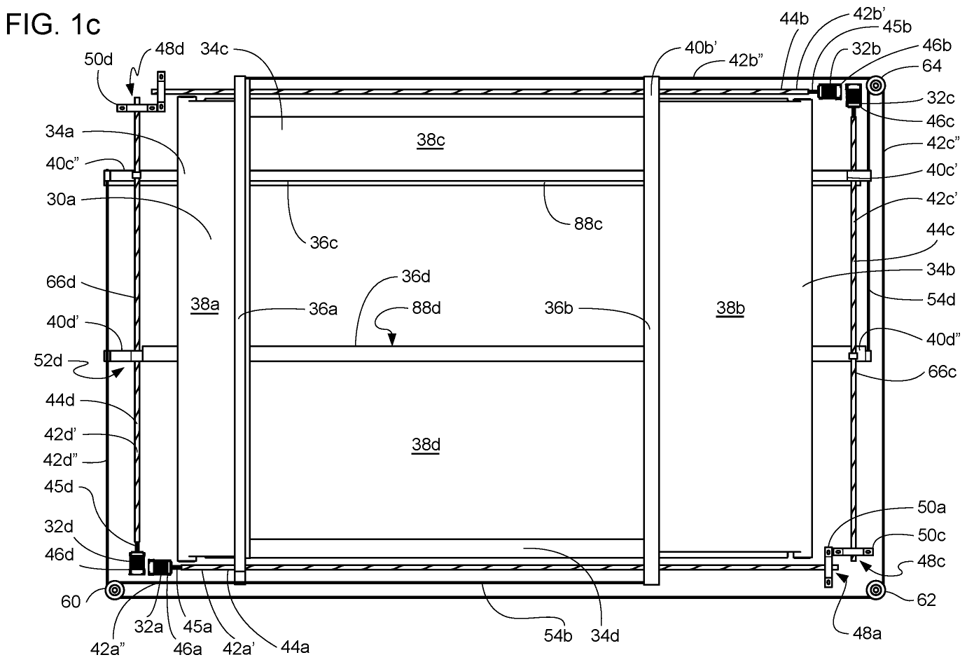

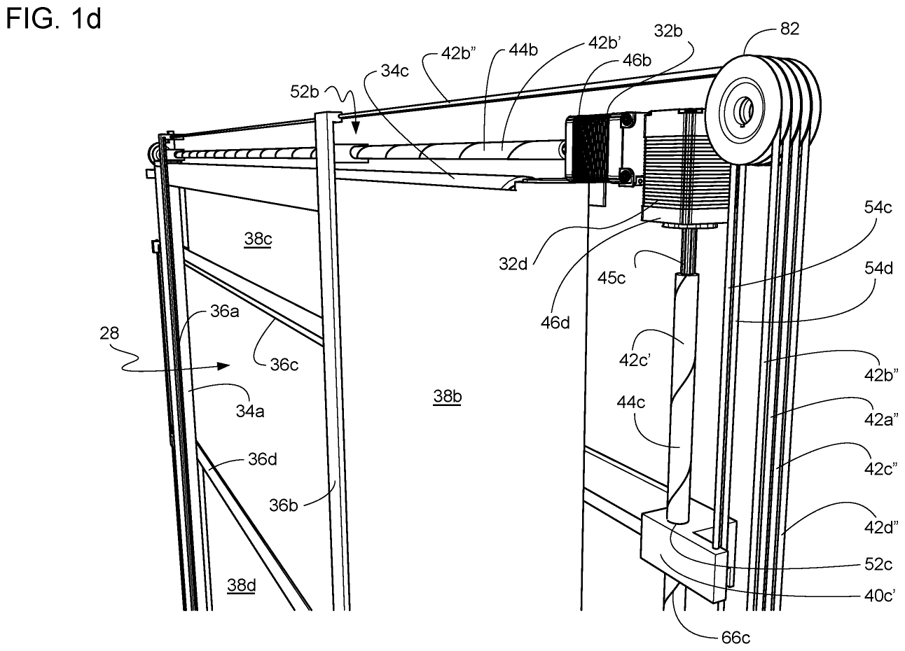

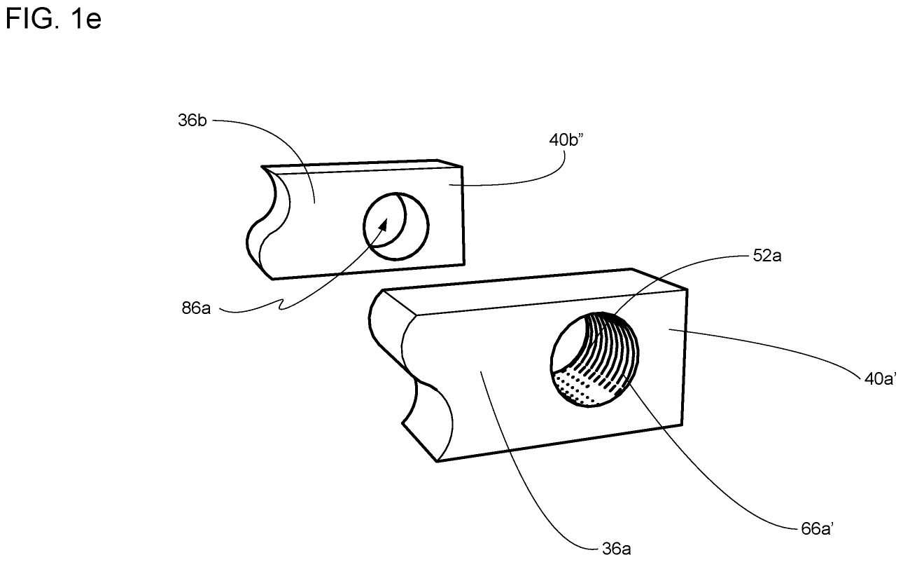

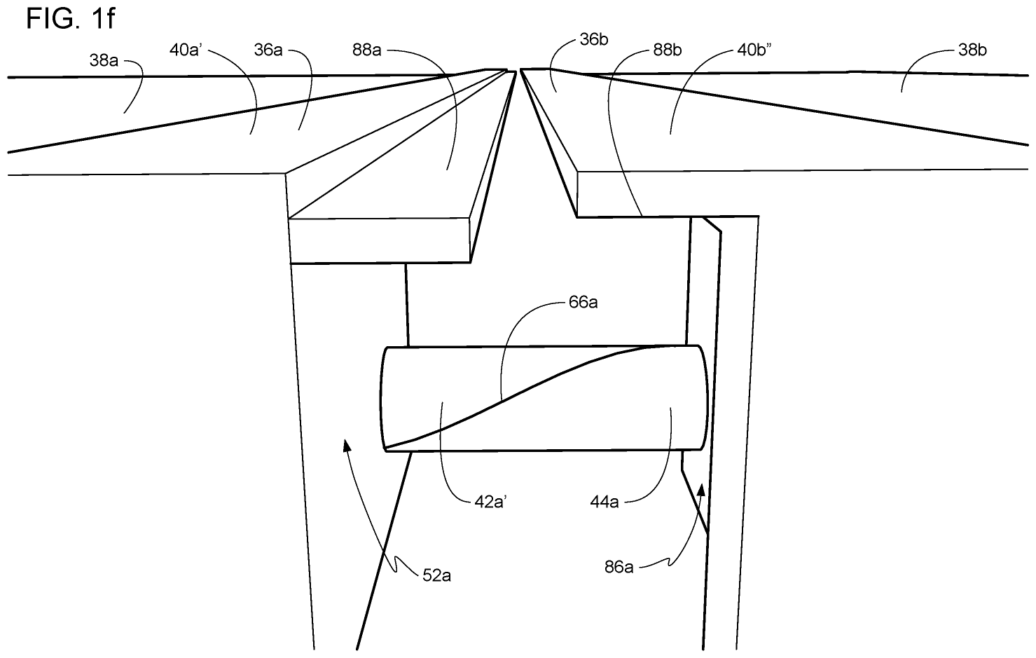

In one embodiment, a device for variably covering area 28 includes shade 30a and driver 32a, as shown in FIG. 1a. Shade 30a includes roller 34a, draw bar 36a, and curtain 38a. Roller 34a is configured for mounting to a fixed position on frame 35 surrounding area 28, as shown in the exploded view of FIG. 1b. Curtain 38a has one end connected to roller 34a and another end connected to draw bar 36a. Curtain 38a is windable on roller 34a to uncover a portion of area 28 and unwindable from the roller to cover a portion of area 28.

Draw bar 36a has two ends, draw bar end 40a′ and draw bar end 40a″ and driver 32a is connected to both of them. Driver 32a is connected to draw bar end 40a′ by way of transmission 42a′. Driver 32a is connected to draw bar end 40a″ by way of transmission 42a″. By simultaneously pulling both of draw bar ends 40a′, 40a″ driver 32a evenly pulls draw bar 36a away from roller 34a, evenly unwinding curtain 38a from roller 34a.

In one embodiment, transmission 42a′ includes lead screw 44a which is supported at one end by axle 45a of motor 46a and at the other end by bearing 48a, which is supported in pillow block 50a. Lead screw 44a extends through lead screw nut 52a. Lead screw nut 52a is connected to and extends through draw bar end 40a′, as shown in FIG. 1a. Lead screws and lead screw nuts are standard parts.

Transmission 42a″ includes cord 54a, which is connected to draw bar end 40a′ and which extends around pulleys 60, 62, and 64 to draw bar end 40a″, as shown in FIG. 1a. Operation of motor 46a turns lead screw 44a. As lead screw 44a rotates, while held in fixed position between motor 46a and pillow block 50a, threads 66a of lead screw nut 52a, riding on grooves 66a of lead screw 44a, pulls draw bar end 40a′ away from roller 34a, as shown in FIGS. 1a, 1d, 1f.

As draw bar end 40a′ moves away from roller 34a, cord 54a of transmission 42a″ is pulled. Via pulleys 60, 62, and 64, cord 54a pulls on draw bar end 40a″ so both ends of draw bar 36a are pulled simultaneously, both by operation of motor 46a and transmissions 42a′, 42a″.

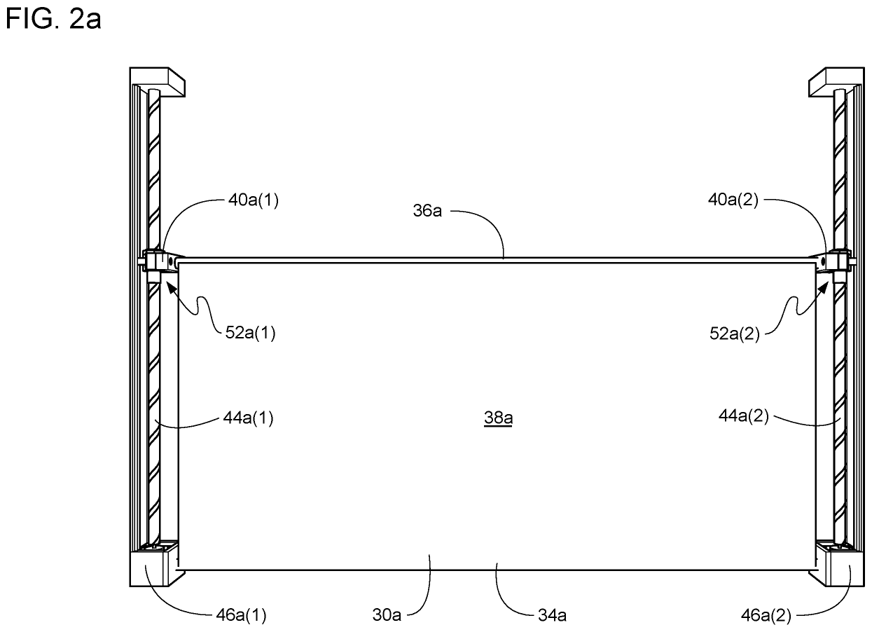

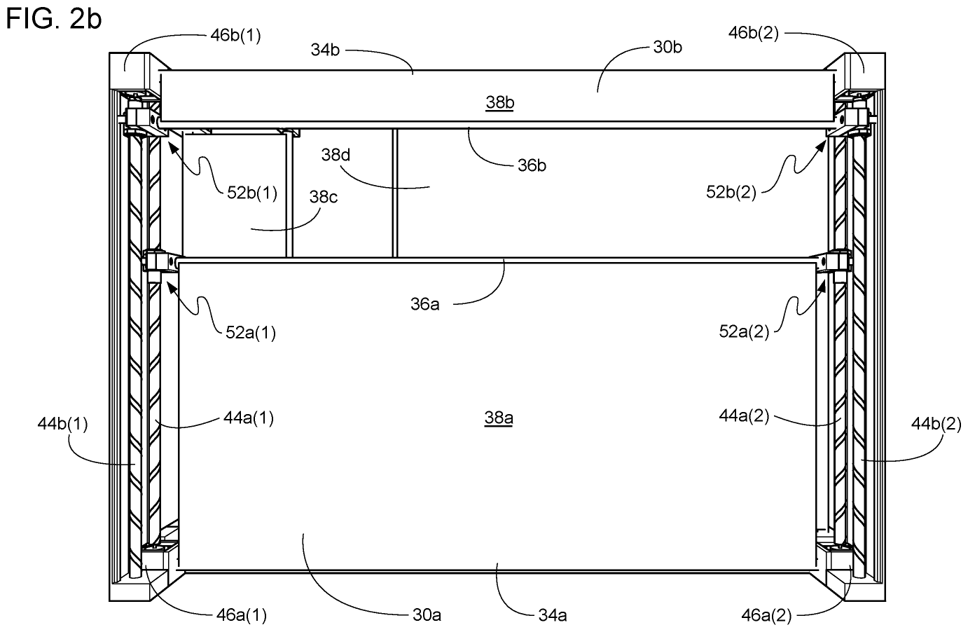

In another embodiment, two sets of simultaneously turned lead screws 44a(1), 44a(2) and lead screw nuts 52a(1), 52a(2) are used, one set on each side of shade 30a, to pull equally on both draw bar ends 40a (1), 40a(2), as shown in FIG. 2a. Thus, cord 54a and pulleys 60, 62, and 64 are replaced by an additional lead screw and lead screw nut to perform the same function of evenly pulling on both ends of draw bar 36a.

In one alternative of this two-lead screw embodiment a central electronic control operates pair of motors, each motor 46a(1), 46a(2) rotating one of the two lead screws 44a(1), 44a(2), as shown in FIG. 2a.

In a prototype used to verify functionality, motors 46a-46d were Nema 17 stepper motors, model 17HD48002H-22B from Zyltech Engineering, Houston, Texas. The motors were controlled by stepper motor drivers DRV8825 from Pololu Robotics & Electronics, Las Vegas, Nev.. The computer used to control the motor drivers was a Model b plus from Raspberry Pi, Cambridge, England.

In one alternative of this two-lead screw embodiment (not shown) a single motor is used, this single motor linked with a gear, belt, chain, cord, or pulley transmission to rotate the two lead screws simultaneously.

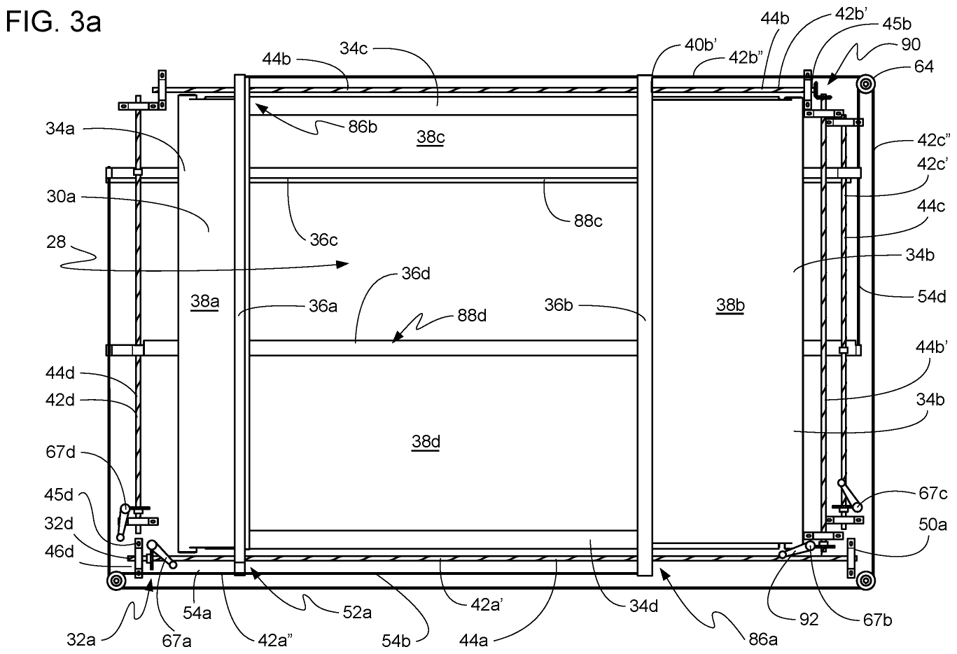

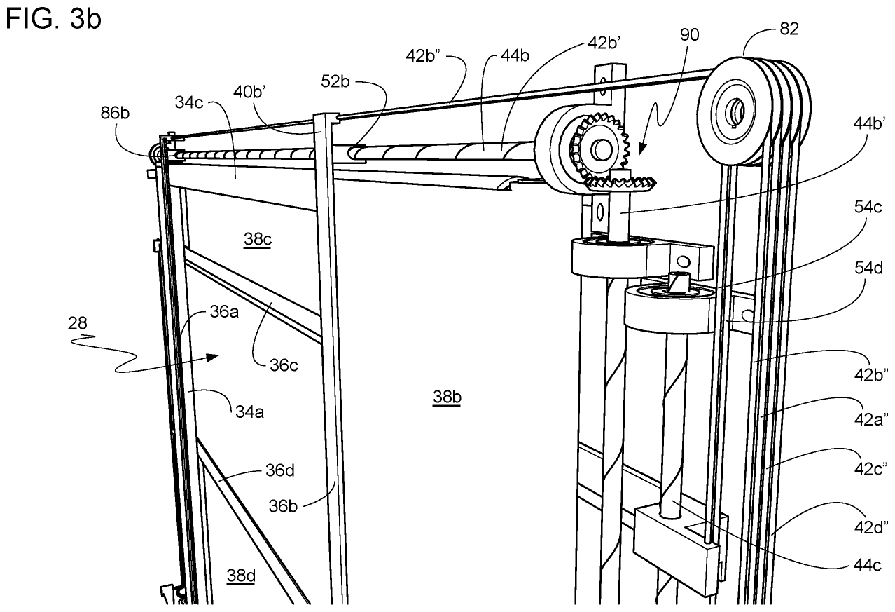

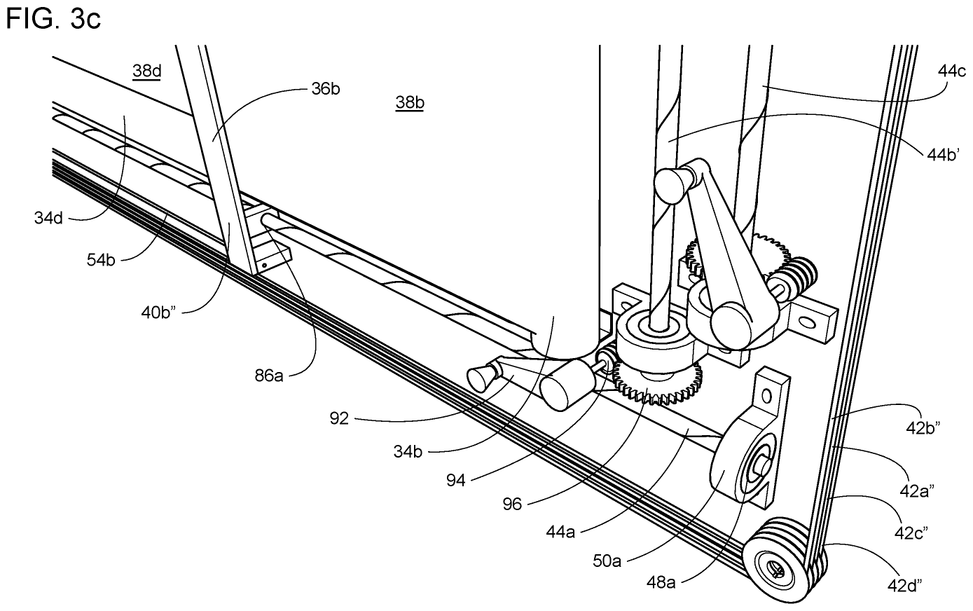

In another embodiment driver 32a includes hand crank 67a, as shown in FIG. 3a. In this embodiment, lead screw 44a of transmission 42a′, and cord 54a of transmission 42a″ are driven by hand crank 67a instead of motor 46a.

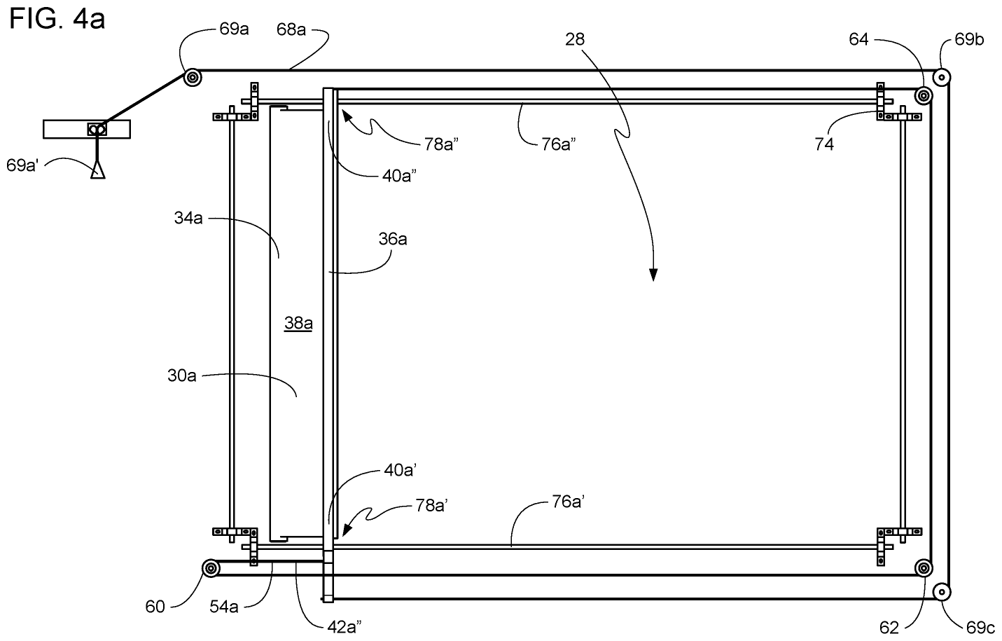

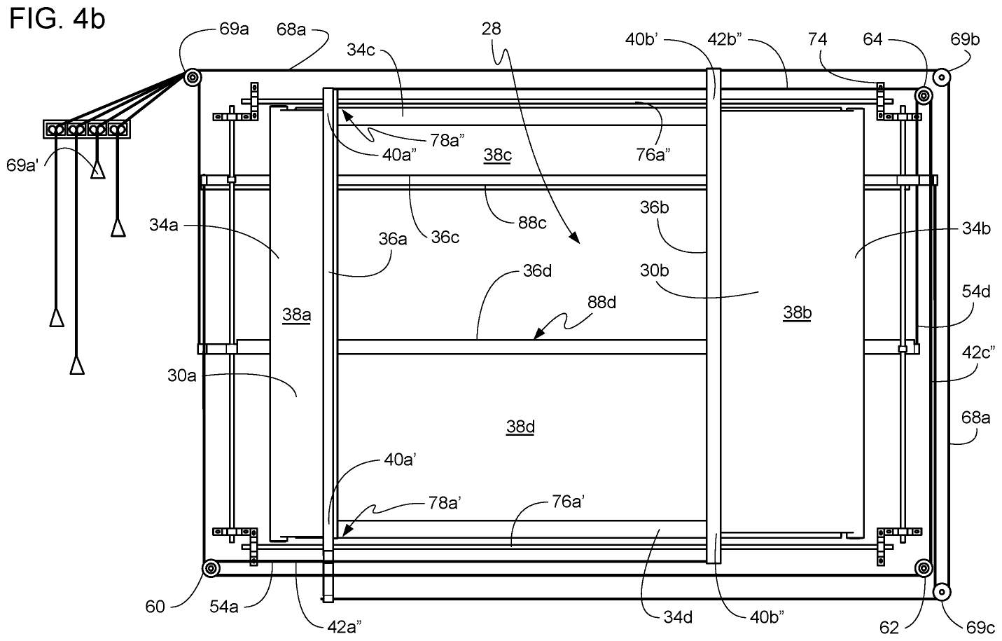

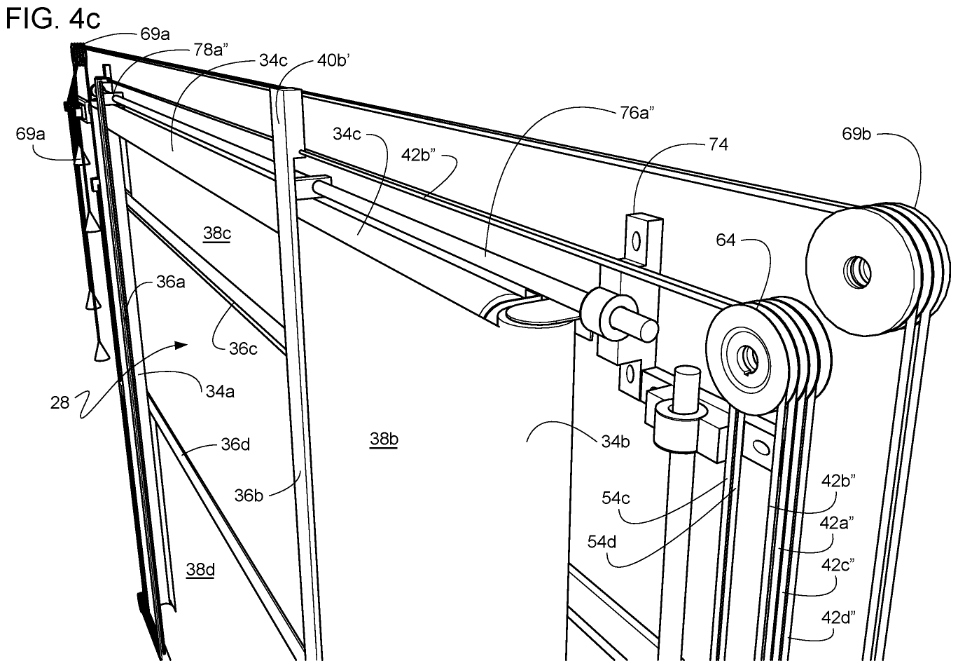

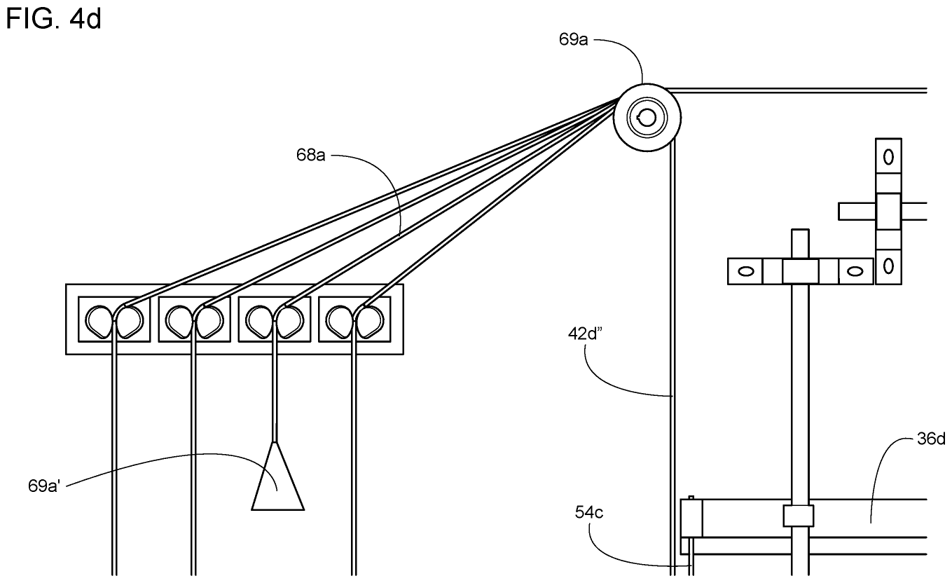

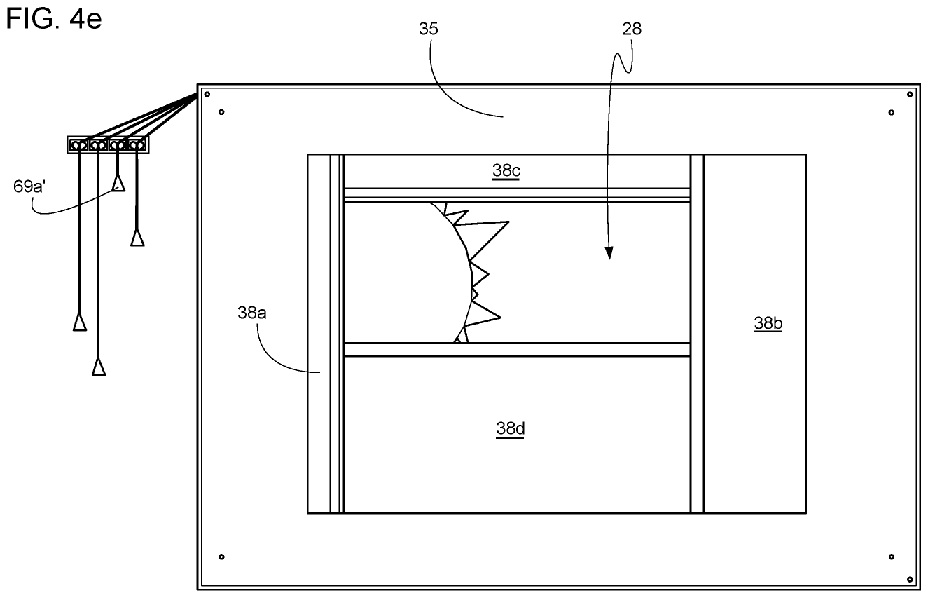

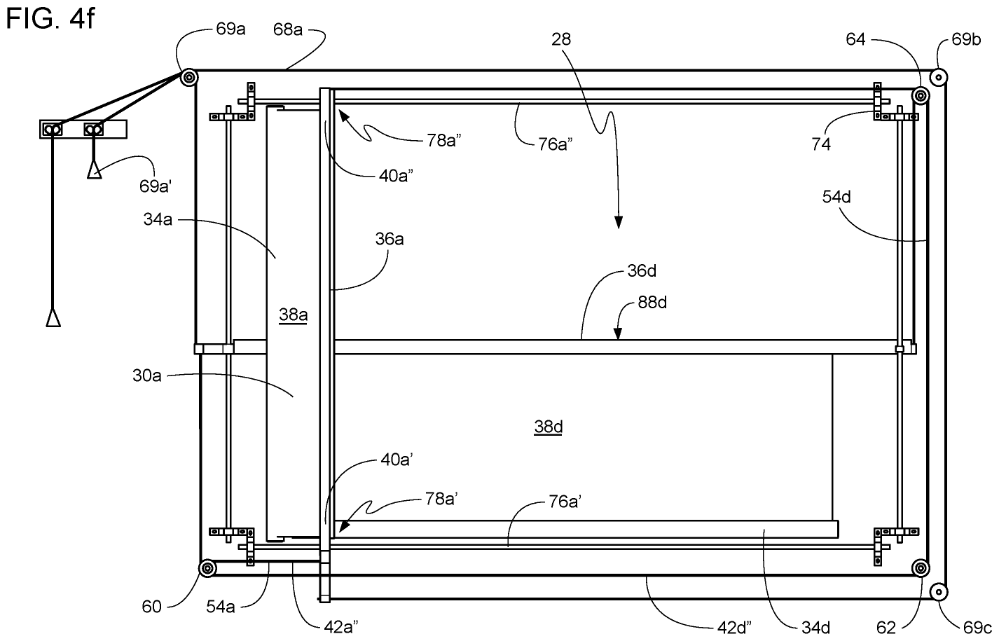

In another embodiment driver 32a and transmission 42a′ are combined in hand pull cord 68a, as shown in FIG. 4a. Hand pull cord 68a may include decoration or counterweight 69a′ Transmission 68a includes three additional pulleys, 69a, 69b, 69c, to transmit force provided by hand pull cord 68a to draw bar end 40a′.

Transmission of the force to draw bar end 40a″ is, as before, along cord 42a″ from draw bar end 40a′ and around pulleys 60, 62, and 64.

In this embodiment, non-rotating support bars 76a′, 76a″ extend through holes or bushings 78a′, 78a″ in draw bar 36a to stabilize draw bar 36a as it slides along support bars 76a′, 76a″. Support bars 76a′, 76a″ are themselves supported by brackets 74.

In these embodiments, roller 34a is spring loaded, so curtain 38a is automatically wound on roller 34a when motor 46a, hand crank 67a, or hand pull cord 68a reverses direction relaxing tension on draw bar 36a and curtain 38a.

Curtain 38a in any of these embodiments may be configured for attenuating light, such as by a light-attenuating fabric. It may also be configured of a material that entirely blocks transmission of light, such as black material.

Second shade 30b and second driver 32b may be included in any of these embodiments, as shown in FIGS. 1a-1c, 2b, 3a-3c, and 4b-4d. Second shade 30b includes second roller 34b, second draw bar 36b, and second curtain 38b. Second roller 34b is configured for mounting in a second fixed position to frame 35 surrounding area 28. Second curtain 38b has one end connected to second roller 34b and another end connected to second draw bar 36b. Second curtain 38b is windable on second roller 34b to uncover a portion of area 28 and unwindable from roller 34b to cover a portion of area 28.

Second shade 30b and second driver 32b work similarly to shade 30a and driver 32a, with similar parts. Second draw bar 36b has 2 ends, draw bar end 40b′ and draw bar end 40b″. Second driver 32b is connected to both of these ends. Second driver 32b is connected to draw bar end 40b″ by way of transmission 42b″. By simultaneously pulling both of draw bar ends 40b′, 40b″ driver 32b evenly pulls draw bar 36b away from roller 34b, evenly unwinding curtain 38b from roller 34b.

In one embodiment, transmission 42b′ includes lead screw 44b which is supported at one end by axle 45b of motor 46b and at the other end by bearing 48b, which is supported in pillow block 50b. Lead screw 44b extends through lead screw nut 52b. Lead screw nut 52b is connected to and extends through draw bar end 40b′, as shown in FIG. 1a and 1d.

Transmission 42b″ includes cord 54b, which is connected to draw bar end 40b′ and which extends around pulleys 64, 62, and 60 to draw bar end 40b″, as shown in FIG. 1a. Stacked pulleys 82 can be used, as shown in FIG. 1d. Operation of motor 46b turns lead screw 44b. As lead screw 44b rotates, while held in position between motor 46b and pillow block 50b, lead screw nut 52b, rides on grooves 66b of lead screw 44b, pulling draw bar end 40b′ away from roller 34b.

As draw bar end 40b′ moves away from roller 34b, cord 54b of transmission 42b″ is pulled. Via pulleys 64, 62, and 60, cord 54b pulls on draw bar end 40b″ so both ends of draw bar 36b are pulled simultaneously, both by operation of motor 46b and transmissions 42b′, 42b″.

Lead screw 44a extends through hole or bushing 86a in draw bar end 40b″, as shown in FIGS. 1a, 1e, providing support for draw bar end 40b″, without changing position of draw bar end 40b″ as lead screw 44a rotates. Similarly, lead screw 44b extends through hole or bushing 86b in draw bar end 40a″, as shown in FIG . 1a, providing support for draw bar end 40a″ without changing position of draw bar end 40a″ as lead screw 44b rotates.

In one embodiment, rollers 34a and 34b are mounted in parallel at opposite ends of area 28, curtain 38a winds in a direction opposite curtain 38b, and draw bars 36a and 36b extend toward each other, as shown in FIG. 1a.

In one alternative, curtain 38a extends in the same plane as curtain 38b. In this embodiment, draw bars 36a and 36b may meet, as also shown in FIG. 1a. Draw bar 36a has element 88a that fits under edge 88b of draw bar 36b, as shown in FIG. if to prevent light leakage there between when draw bar 36a extends to draw bar 36b.

In another embodiment, the two rollers are mounted orthogonal to each other, as shown for rollers 34a and 34c in FIGS. 1b-1d, 3a-3c, 4b-4c, 4e-4f. In this embodiment the draw bars move orthogonal to each other. Also, in this embodiment, the two curtains 38a, 38c extend in different planes so they do not interfere with each other when extending or retracting.

Any of these embodiments may include third shade 30c and third driver 32c, as shown in FIGS. 1b-1c, 3a-3b, and 4b-4c. Third shade 30c includes third roller 34c, third draw bar 36c, and third curtain 38c. Third roller 34c is configured for mounting to a fixed position on frame 35 surrounding area 28, as shown in the exploded view of FIG. 1b. Third curtain 38c has one end connected to third roller 34c and another end connected to third draw bar 36c. Third curtain 38c is windable on third roller 34c to uncover a portion of area 28 and unwindable from roller 34c to cover a portion of area 28.

In this embodiment, third draw bar 36c has two ends, draw bar end 40c′ and draw bar end 40c″. Third driver 32c is connected to both of these ends. Third driver 32c is connected to draw bar end 40c″ by way of transmission 42c″. By simultaneously pulling both of draw bar ends 40c′, 40c″ driver 32c evenly pulls draw bar 36c away from roller 34c, evenly unwinding curtain 38c from roller 34c.

In one embodiment, transmission 42c′ includes lead screw 44c which is supported at one end by axle 45c of motor 46c and at the other end by bearing 48c, which is supported in pillow block 50c. Lead screw 44c extends through lead screw nut 52c. Lead screw nut 52c is connected to and extends through draw bar end 40c′, as shown in FIG. 1c and 1d.

Transmission 42c″ includes cord 54c, which is connected to draw bar end 40c′ and which extends around pulleys 64, 62, and 60 to draw bar end 40c″, as shown in FIG. 1c. Operation of motor 46c turns lead screw 44c. As lead screw 44c rotates, while held in position between motor 46c and pillow block 50c, lead screw nut 52c, rides on grooves 66c of lead screw 44c, pulling draw bar end 40c′ away from roller 34c.

As draw bar end 40c′ moves away from roller 34c, cord 54c of transmission 42c″ is pulled. Via pulleys 64, 62, and 60, cord 54c pulls on draw bar end 40c″ so both ends of draw bar 36c are pulled simultaneously, both by operation of motor 46c and transmissions 42c′, 42c″.

In one embodiment, rollers 34a and 34b are mounted in parallel at opposite ends of area 28, and roller 34c is mounted orthogonal to rollers 34a, 34b so curtain 38c extends in a plane different from the plane or planes of curtains 34a, 34b.

This embodiment may also include fourth shade 30d and fourth driver 32d, as shown in FIGS. 1b-1d, 2b, 3a-3b, and 4b-4c. Fourth shade 30d includes fourth roller 34d, fourth draw bar 36d, and fourth curtain 38d. Fourth roller 34d is configured for mounting to a fixed position on frame 35 surrounding area 28, as shown in the exploded view of FIG. 1b. Fourth curtain 38d has one end connected to fourth roller 34d and another end connected to fourth draw bar 36d. Fourth curtain 38d is windable on fourth roller 34d to uncover a portion of area 28 and unwindable from roller 34d to cover a portion of area 28.

In this embodiment, fourth draw bar 36d has two ends, draw bar end 40d′ and draw bar end 40d″. Fourth driver 32d is connected to both of these ends. Fourth driver 32d is connected to draw bar end 40d″ by way of transmission 42d″. By simultaneously pulling both of draw bar ends 40d′, 40d″ driver 32d evenly pulls draw bar 36d away from roller 34d, evenly unwinding curtain 38d from roller 34d.

In one embodiment, transmission 42d′ includes lead screw 44d which is supported at one end by axle 45d of motor 46d and at the other end by bearing 48d, which is supported in pillow block 50d. Lead screw 44d extends through lead screw nut 52d. Lead screw nut 52d is connected to and extends through draw bar end 40d′, as shown in FIG. 1c.

Transmission 42d″ includes cord 54d, which is connected to draw bar end 40d′ and which extends around pulleys 60, 62, and 64 to draw bar end 40d″, as shown in FIG. 1c. Operation of motor 46d turns lead screw 44d. As lead screw 44d rotates, while held in position between motor 46d and pillow block 50d, lead screw nut 52d rides on grooves 66d of lead screw 44d, pulling draw bar end 40d′ away from roller 34d.

As draw bar end 40d′ moves away from roller 34d, cord 54d of transmission 42d″ is pulled. Via pulleys 60, 62, and 64, cord 54d pulls on draw bar end 40d″ so both ends of draw bar 36d are pulled simultaneously, both by operation of motor 46d and transmissions 42d′, 42d″.

In one embodiment, rollers 34a and 34b are mounted in parallel at opposite ends of area 28, and rollers 34c and 34d are mounted orthogonal to rollers 34a, 34b.

In one alternative, curtain 38c extends in the same plane as curtain 38d and this plane is different from the plane or planes of curtains 38a, 38b. In this embodiment, draw bars 36c and 36d may meet. Draw bar 36c has edge 88c that fits within groove 88d in draw bar 36d. In one alternative, curtain 38a extends in the same plane as curtain 38b and curtain 38c extends in the same plane as curtain 38d and this plane is different from the plane or planes of curtains 38a, 38b.

In another alternative, curtain 38c extends in a plane different from curtain 38d. Curtains 38a, 38b, 38c, and 38d may all extend in different planes, one in front of the other so each one can operate independent of the position of the others.

In the embodiment with two sets of simultaneously turned lead screws 44a(1), 44a(2), second pair of lead screws 44b(1), 44b(2), lead screw nuts 52b(1), 52b(2), and motors 46b(1), 46b(2) is used to operate second shade 30b, as shown in FIG. 2b. Similarly, in an embodiment with a third shade, an additional pair of lead screws, lead screw nuts, and motors are used to operate the third shade (not shown). Similarly, in an embodiment with a fourth shade, another additional pair of lead screws, lead screw nuts and motors is used to operate the fourth shade (not shown).

In the embodiment in which driver 32a includes hand crank 67a, additional hand cranks 67b, 67c, 67d operate additional lead screws 44b, 44c, and/or 44d of transmission 42a′ 42b′, 42c′ and cord 54b, 54c, 54d of transmission 42b″, 42c″, 42d″, as shown in FIGS. 3a-3c. In one embodiment, four hand cranks are in accessible lower portions of frame 35 and bevel gear 90 transmits rotation to topmost lead screw 44b. For example, hand crank 67b operates with handle 92 turning worm drive 94 which turns worm wheel 96 which turns lead screw 44b′ which turns bevel gear 90.

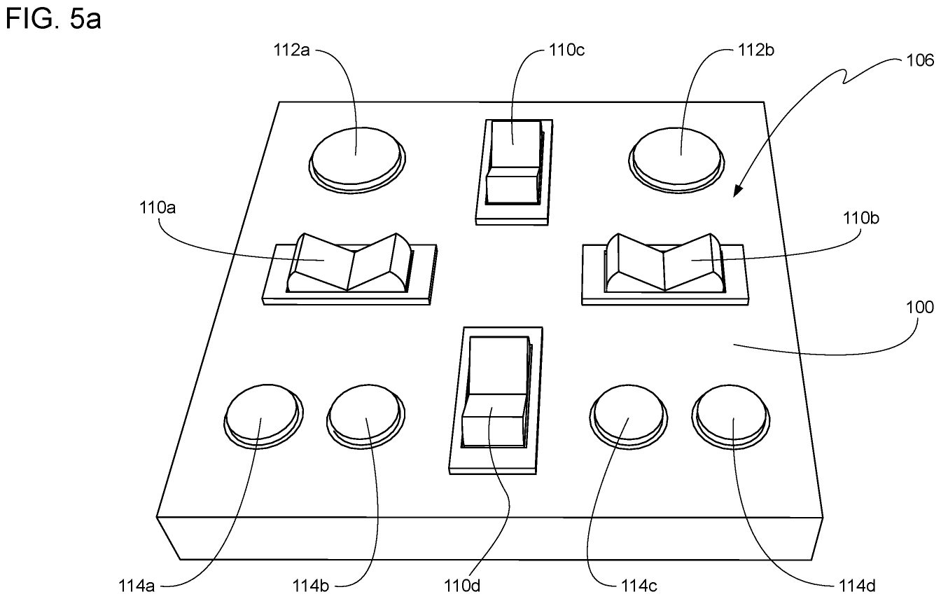

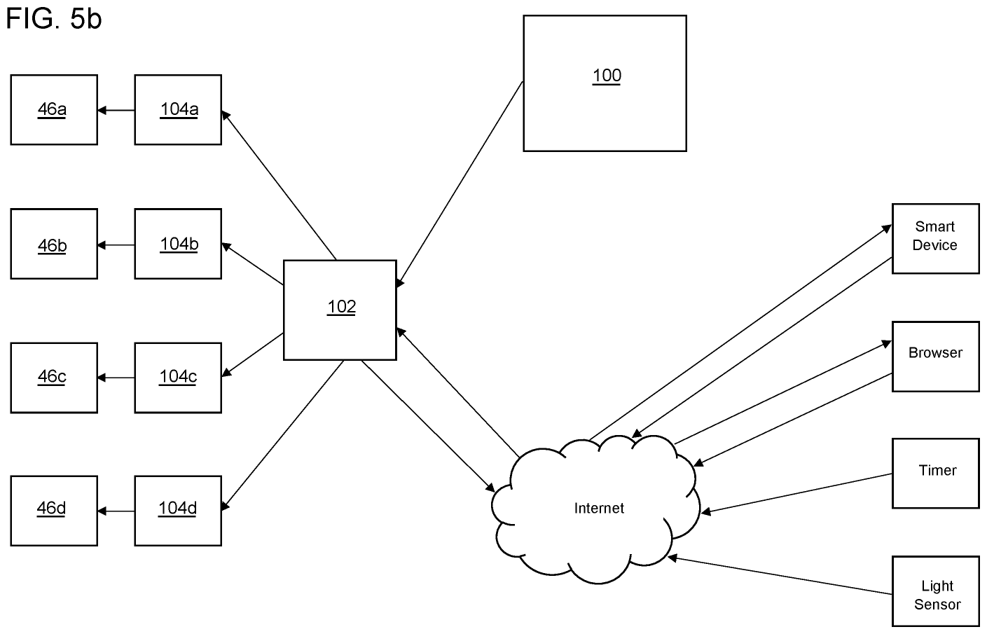

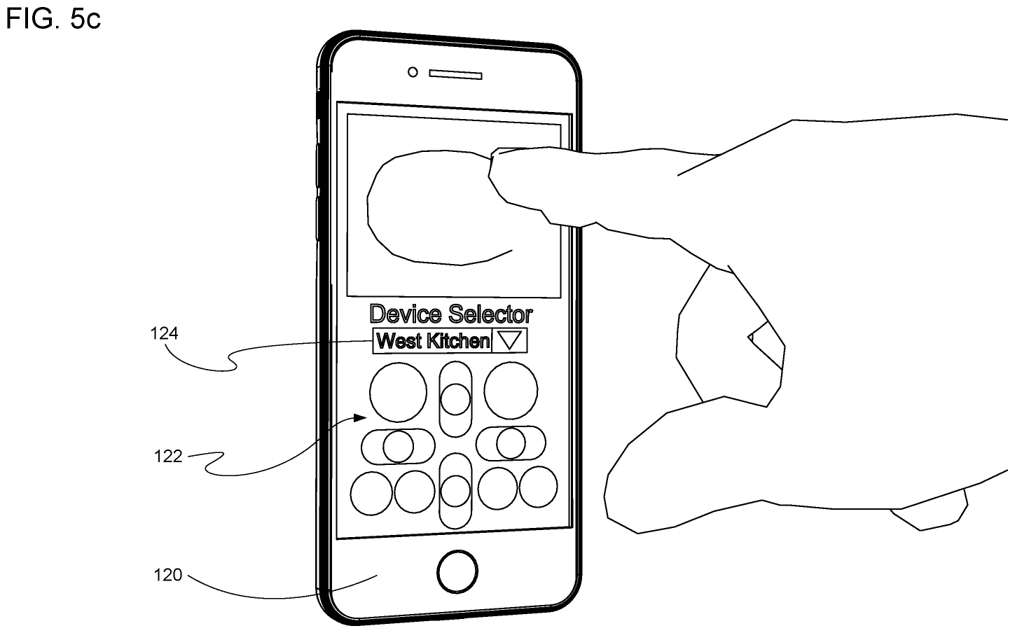

In one embodiment, motors 46a-46d are operated with controller 100 that is mounted to frame 35, as shown in FIGS. 1b, 5a. Controller 100 includes CPU 102, motor drivers 104a-104d, button interface 106, and power supply (not shown). CPU 102 includes a microprocessor and memory/storage. Button interface 106 includes rocker switches 110a-110d for controlling motors 46a-46d for opening and/or closing each shade 30a-30d an amount determined by how long rocker switches 110a-110d are in their on positions. Button interface 106 also includes buttons 112a, 112b for operating motors 46a-46d to fully open or fully close all shades at once. Button interface 106 also includes buttons 114a-114d for operating motors 46a-46d to open shades to preset positions. A program running on CPU 102 provides for directing motor drivers 104a-104d to turn on motors 46a-46d to rotate clockwise or counterclockwise based on direction provided from rocker switches 110a-110d, buttons 112a, 112b, and buttons 114a-114d. Button interface 106 may be implemented with actual rocker switches and buttons or it may be implemented with a touch screen.

In another embodiment, motors 46a-46d are operated with hand-held mobile device 120 that has touch screen 122, as shown in FIG. 5c. A program, operating on hand-held mobile device 120 first allows a user to select which window shade system to adjust with device selector 124. Then it provides images of rocker switches and buttons on touch screen 122 for operating motors 46a-46d of the selected device. Alternatively, the program allows the user to draw an image of the desired positions of shades 30a-30d, such as by drawing an oval with a finger motion, as shown in FIG. 5c.

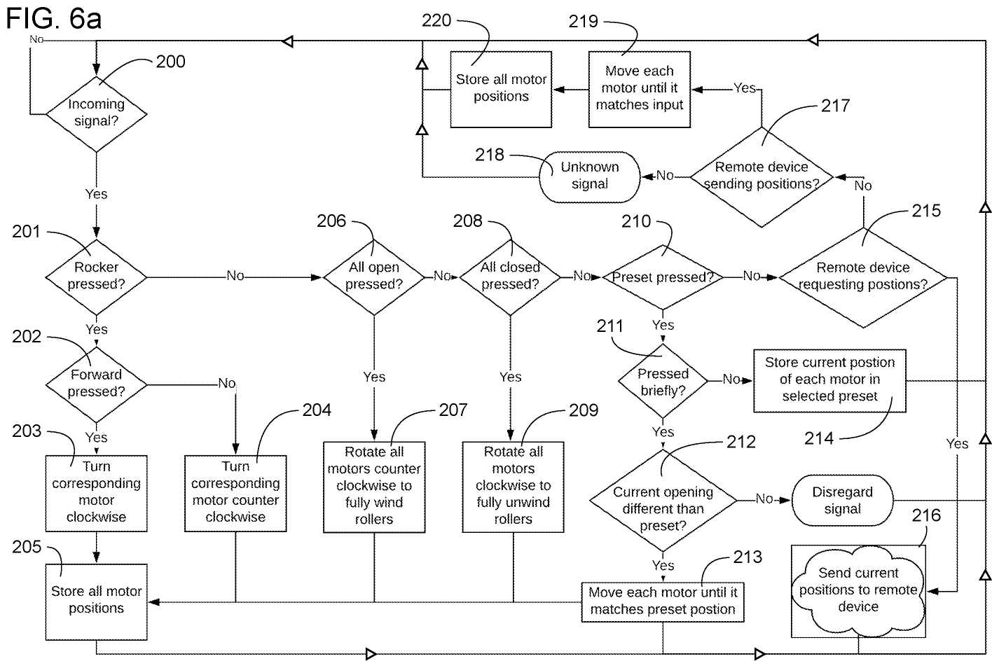

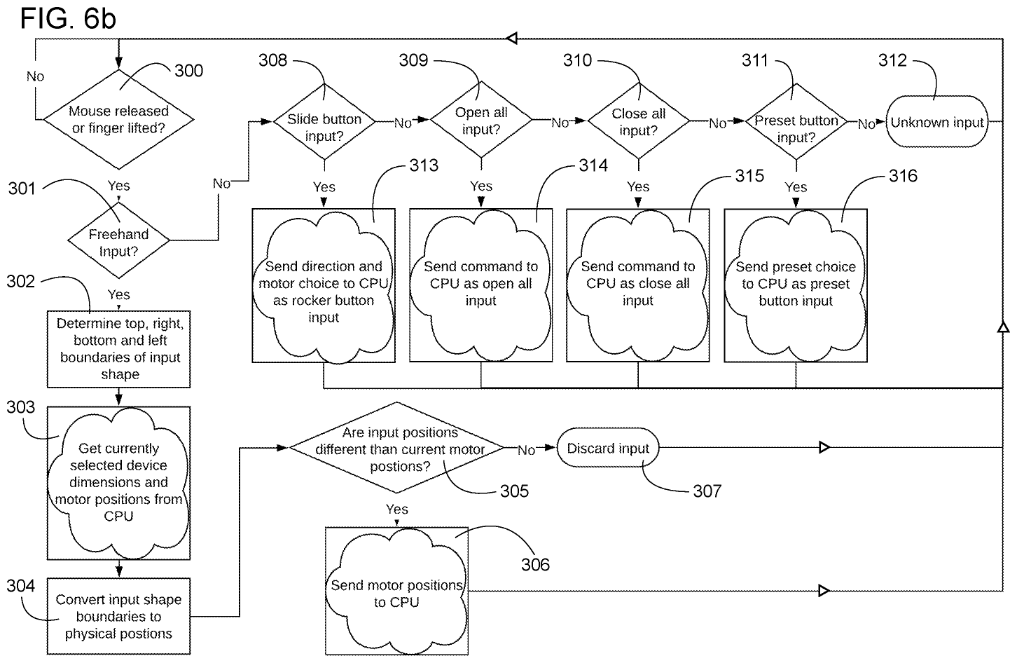

A flow chart showing steps of a process running on CPU 102 used to operate motors 46a-46d when controller 100 is used is shown in FIG. 6a. In step 200 CPU 102 checks whether there is an incoming signal. If not this step is repeated. If yes, CPU 102 checks whether any of rocker switches 110a-110d is pressed, as shown in step 201. If yes, CPU 102 checks whether forward is pressed on any of rocker switches 110a-110d. If yes, CPU 102 directs the corresponding motor driver 104a-104d to turn corresponding motor 46a-46d clockwise, as shown in step 203. If no, CPU 102 directs the corresponding motor driver 104a-104d to turn corresponding motor 46a-46d counterclockwise, as shown in step 204. In either case, CPU 102 directs storage of all motor positions, as shown in box 205.

If no rocker switch 110a-110d is pressed, as shown in step 201, CPU 102 checks whether “all open” button 112a is pressed, as shown in box 206. If yes, then CPU 102 directs all motor drivers 104a-104d to turn their corresponding motors 46a-46d counterclockwise, as shown in box 207 to fully allow springs in rollers 34a-34d to pull on all curtains 38a-38d, wind all rollers 34a-34d, move all draw bars 36a-36d toward corresponding rollers 34a-34d, and open all shades 30a-30d.

If “all open” button 112a is not pressed, then CPU 102 checks whether “all closed” button 112b is pressed, as shown in box 208. If yes, then CPU 102 directs all motor drivers 104a-104d to turn their corresponding motors 46a-46d clockwise, as shown in box 209 to fully move draw bars 36a-36d away from corresponding rollers 34a-34d, unwinding rollers 34a-34d, and closing all shades 30a-30d. In the embodiment where opposing shades are in the same plane, “all closed” has draw bar 36a meeting draw bar 36b and draw bar 36c meeting draw bar 36d. In the embodiment where opposing shades are al in different planes, “all closed” has draw bar 36a, 36b, 36c, 36d, all fully extended across opening 28.

If “all closed” button 112b is not pressed, then CPU 102 checks whether any of “preset” buttons 114a-114d is pressed, as shown in box 210. If yes, then CPU 102 checks whether any of “preset” buttons 114a-114d is tapped briefly, as shown in box 211. If yes, then CPU 102 checks whether the current operating position of shade 30a-30d, as determined from motor position, is different from what its corresponding “preset” button 114a-114d directs, as shown in box 212. If so, then CPU 102 directs corresponding motor driver 104a-104d to move its corresponding motor 46a-46d until it matches the preset condition, as shown in box 213. If any of “preset” buttons 114a-114d is pressed for an extended time then CPU 102 stores in memory the current position of each motor, as shown in box 214.

If any of “preset” buttons 114a-114d is not pressed, as shown in box 210, then CPU 102 checks whether a remote device is requesting position information, as shown in box 215. If yes, then CPU 102 sends the current positions of shades 30a-30d to the remote device, such as via the internet, as shown in box 216. The program then directs CPU 102 to check for the next incoming signal, as shown in box 200.

If no remote device is requesting position information, as shown in box 215, then CPU 102 checks whether a remote device is sending position information, as shown in box 217. If not, then CPU 102 determines that the incoming signal was an unknown signal, as shown in box 218. The program then directs CPU 102 to check for the next incoming signal, as shown in box 200.

If a remote device is sending position information, as shown in box 217, then CPU 102 directs corresponding motor driver 104a-104d to move its corresponding motor 46a-46d until it matches the input from the sending remote device, as shown in box 219, and all motor positions are stored, as shown in box 220. The program then directs CPU 102 to check for the next incoming signal, as shown in box 200.

A flow chart showing steps of a process running on CPU 102 used to operate motors 46a-46d when a computing device, such as hand-held mobile device 120, is used to issue instruction for operation of motors 46a-46d, is shown in FIG. 6b. A laptop or desktop computer (not shown) can also be used.

A microprocessor (not shown) running on hand-held mobile device 120 checks whether a finger has been lifted from screen 122 of hand-held mobile device 120, as shown in box 300. If no finger has been lifted, this step is repeated. If yes, the microprocessor checks whether there was a freehand input to screen 122, as shown in step 301. If yes, a program running on the microprocessor of hand-held mobile device 120 determines top, right, bottom, and left boundaries of the input shape that was drawn by the user's finger on screen 122, as shown in step 302. The microprocessor then obtains the dimensions and current motor positions of currently selected device 124 from memory in CPU 102, as shown in box 303. The hand-held mobile device microprocessor then converts the input-shape boundaries input by the user to physical positions of shades 30a-30d, as shown in box 304.

Then the processor in hand-held mobile device 120 determines whether the positions input by the user are different from the current motor positions determined in box 303, as shown in box 305. If different, CPU 102 directs motor drivers 104a-104d to move their corresponding motors 46a-46d until they match the positions specified by the user, as shown in box 306. If input positions as determined from screen 122 are not different from the current shade positions, as shown in query box 305, then input is discarded, as shown in box 307. In either case the program then directs the processor in hand-held mobile device 120 to check for any further direction from the user, as shown in box 300.

If there has been no freehand input from the user to screen 122, as shown in step 301, the hand-held mobile device microprocessor then checks whether there has been a slide button input, as shown in FIG. 308. If not a slide button input, the hand-held mobile device microprocessor then checks whether there has been an “open all” input, as shown in FIG. 309. If no “open all” input, the hand-held mobile device microprocessor then checks whether there has been a “close all” input, as shown in FIG. 310. If no “close all” input, the hand-held mobile device microprocessor then checks whether there has been a “preset button” input, as shown in FIG. 311. If no “preset button” input, the hand-held mobile device microprocessor then determines that the freehand input of box 301 was an unknown input, as shown in box 312.

If the hand-held mobile device microprocessor finds that any of steps 308 to 311 is yes, the microprocessor sends the corresponding direction to motor driver 104a-104d to turn motor 46a-46d as described herein above for controller 100, as shown in boxes 313-316.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

1. A device for variably covering an area, comprising a first shade and a first driver, wherein said first shade includes a first roller, a first draw bar, and a first curtain, wherein said first roller is configured for mounting in a first fixed position, wherein said first curtain has one end connected to said first roller and another end connected to said first draw bar, wherein said first curtain is windable on said first roller to uncover the area and unwindable from the roller to cover the area, wherein said first draw bar includes two ends, wherein said first driver is connected to said two ends for evenly pulling said first draw bar away from said first roller and unwinding said first curtain.

2. A device as recited in claim 1, wherein said first driver includes a motor.

3. A device as recited in claim 1, wherein said first driver includes a first lead screw and wherein said first draw bar includes a first lead screw nut.

4. A device as recited in claim 3, wherein said first driver includes a first motor, wherein said first lead screw is driven by said first motor.

5. A device as recited in claim 3, wherein said first driver includes a first hand crank, wherein said first lead screw is driven by said first hand crank.

6. A device as recited in claim 1, wherein said first driver includes a first cord and wherein said first draw bar includes a first-cord draw bar connector.

7. A device as recited in claim 6, wherein said first driver includes a first pulley and wherein said first cord extends around said first pulley.

8. A device as recited in claim 7, further comprising a first counterweight, wherein said first cord extends between said first counterweight and said first pulley.

9. A device as recited in claim 1, wherein said first roller is spring loaded.

10. A device as recited in claim 1, wherein said first curtain is configured for attenuating light.

11. A device as recited in claim 1, further comprising a second shade and a second driver, wherein said second shade includes a second roller, a second draw bar, and a second curtain, wherein said second roller is configured for mounting in a second fixed position, wherein said second curtain has one end connected to said second roller and another end connected to said second draw bar, wherein said second curtain is windable on said second roller to uncover the area and unwindable from the roller to cover the area, wherein said second draw bar includes two ends, wherein said second driver is connected to said two ends for evenly pulling said second draw bar away from said second roller and unwinding said second curtain.

12. A device as recited in claim 11, wherein said first curtain extends in a plane in front of said second curtain.

13. A device as recited in claim 11, wherein said first curtain extends in the same plane as said second curtain and wherein said first curtain winds in a direction opposite said second curtain.

14. A device as recited in claim 11, wherein said first roller extends orthogonal to said second roller.

15. A device as recited in claim 11, wherein said first roller extends parallel to said second roller.

16. A device as recited in claim 11, further comprising a third shade and a third driver, wherein said third shade includes a third roller, a third draw bar, and a third curtain, wherein said third roller is configured for mounting in a third fixed position, wherein said third curtain has one end connected to said third roller and another end connected to said third draw bar, wherein said third curtain is windable on said third roller to uncover the area and unwindable from the roller to cover the area, wherein said third draw bar includes two ends, wherein said third driver is connected to said two ends for evenly pulling said third draw bar away from said third roller and unwinding said third curtain.

17. A device as recited in claim 16, further comprising a fourth shade and a fourth driver, wherein said fourth shade includes a fourth roller, a fourth draw bar, and a fourth curtain, wherein said fourth roller is configured for mounting in a fourth fixed position, wherein said fourth curtain has one end connected to said fourth roller and another end connected to said fourth draw bar, wherein said fourth curtain is windable on said fourth roller to uncover the area and unwindable from the roller to cover the area, wherein said fourth draw bar includes two ends, wherein said fourth driver is connected to said two ends for evenly pulling said fourth draw bar away from said fourth roller and unwinding said fourth curtain.

18. A device for variably covering an area, comprising a first shade and a second shade, wherein said first shade includes a first roller, a first draw bar, and a first curtain, wherein said first roller is configured for mounting in a first fixed position, wherein said first curtain has one end connected to said first roller and another end connected to said first draw bar, wherein said second shade includes a second roller, a second draw bar, and a second curtain, wherein said second roller is configured for mounting in a second fixed position substantially orthogonal to said first roller, wherein said second curtain has one end connected to said second roller and another end connected to said second draw bar, wherein when said first and said second curtains are extended to cover the area, said first curtain extends in a plane in front of said second curtain.

19. A device as recited in claim 18, further comprising a third shade, wherein said third shade includes a third roller, a third draw bar, and a third curtain, wherein said third curtain has one end connected to said third roller and another end connected to said third draw bar, wherein said third roller is configured for mounting in a third fixed position substantially parallel to said first roller.

20. A device as recited in claim 19, further comprising a fourth shade, wherein said fourth shade includes a fourth roller, a fourth draw bar, and a fourth curtain, wherein said fourth curtain has one end connected to said fourth roller and another end connected to said fourth draw bar, wherein said fourth roller is configured for mounting in a fourth fixed position substantially parallel to said second roller.

21. A device as recited in claim 20, wherein when said first curtain and said third curtain are extended to cover the area said third curtain lies in the same plane as said first curtain, and wherein when said second curtain and said fourth curtain are extended to cover the area, said fourth curtain lies in the same plane as said second curtain.

22. A device as recited in claim 20, wherein when said first curtain, said second curtain, said third curtain, and said fourth curtain are all extended to cover the area, said second curtain extends in a plane in front of said third curtain and said third curtain extends in a plane in front of said fourth curtain.

23. A device as recited in claim 18, further comprising a first driver, wherein said first driver is configured to provide a drive force on said first draw bar to drive said first draw bar away from said first roller.

24. A device as recited in claim 23, wherein said first roller includes a first spring, wherein said first spring is configured to automatically wind said first curtain on said first roller when said first driver releases drive force on said first draw bar.

25. A device as recited in claim 23, wherein said first driver includes a first drive member and a first transmission.

26. A device as recited in claim 25, wherein said first drive member includes at least one from the group consisting of a first pull cord, a first hand crank, and a first motor.

27. A device as recited in claim 25, wherein said first transmission includes a first lead screw and a first lead screw nut, wherein said first drive member is connected to rotate said first lead screw, wherein said first lead screw nut is connected to said first draw bar, and wherein said first lead screw nut rides on said first lead screw.

28. A device as recited in claim 25, further including a first base, wherein said first lead screw nut includes a first support pin, wherein said first support pin extends to said first base.

29. A device as recited in claim 25, further including a first pillow block, wherein said first pillow block includes a first bearing, wherein said first lead screw includes an end coupled to said first drive member and an end supported by said first bearing.

30. A device as recited in claim 18, wherein said curtain is configured for attenuating light.

31. A method of using a device for variably covering an area, comprising:
a. providing a first shade and a second shade, wherein said first shade includes a first roller, a first draw bar, and a first curtain, wherein said first curtain has one end connected to said first roller and another end connected to said first draw bar, wherein said second shade includes a second roller, a second draw bar, and a second curtain, wherein said second curtain has one end connected to said second roller and another end connected to said second draw bar;
b. mounting said first roller in a first fixed position; and
c. mounting said second roller in a second fixed position substantially orthogonal to said first roller, wherein when said first and said second curtains are extended, said first curtain extends in a plane in front of said second curtain.

32. A method as recited in claim 31, further comprising providing a third shade, wherein said third shade includes a third roller, a third draw bar, and a third curtain, wherein said third curtain has one end connected to said third roller and another end connected to said third draw bar, further comprising mounting said third roller in a third fixed position substantially parallel to said first roller.

33. A device as recited in claim 32, further comprising providing a fourth shade, wherein said fourth shade includes a fourth roller, a fourth draw bar, and a fourth curtain, wherein said fourth curtain has one end connected to said fourth roller and another end connected to said fourth draw bar, further comprising mounting said fourth roller in a fourth fixed position substantially parallel to said second roller.
